(19) United States
(12) Patent Application Publication
(10) Pub. No.: US 2004/0046801 A1
(43) Pub. Date: Mar. 11, 2004

(54) System and method for constructing an interactive video menu

(76) Inventors: Liang-Jin Lin, Taipei (TW); Miin Fang Liaw, Taipei (TW)

Correspondence Address: RABIN & Berdo, PC, 1101 14TH STREET, NW, SUITE 500, WASHINGTON, DC, 20005, US

(21) Appl. No.: 10/235,886

(22) Filed: Sep. 6, 2002

(51) Int. Cl. G09G 5/00

(52) U.S. Cl. 345/810

(57) ABSTRACT

A method and system is disclosed to construct an interactive video menu. In the invention, an interactive video project is first established. One or more video clips are added to the interactive video project, with each of the video clips represented with a video frame contained therein. Thereafter, each of the video clips is parsed to identify one or more video chapters included in the video clip, with each of the video chapters also represented with a video frame contained therein. Therefore, a 2-level interactive video menu is created based on a menu template and hierarchical relationship between the video clips and their corresponding video chapters, with the first-level menu including one or more items respectively linked to second-level menus for the corresponding video clips, and the second-level menu including one or more items linked to playback commands for the corresponding video chapters in response to a user selection.

### BACKGROUND OF THE INVENTION

1. Field of the Invention

This invention relates to an interactive video authoring system, and particularly to a system and a method capable of instructing and allowing a user to automatically construct an interactive video menu during the authoring of an interactive video.

2. Description of the Related Art

For memory, record and other purposes, an increasing number of users nowadays use equipment, such as digital video cameras, to shoot digital video clips for storage in a computer system or for transfer via the Internet. Moreover, due to the advancements of digital multimedia industry, the users can also combine and reorganize the shot video clips into one, with the help of a video authoring system, and have the resulting video burned onto any storage means such as compact disc, with suitable modifications directly made on it.

In this case, there is a need to access or play a certain portion such as a video clip of the resulting video. As a result, an interactive video menu is proposed to enhance and the interactivity. An interactive video menu is a menu frame included in an interactive video, in which one or more items such as icons or texts are allocated and linked to the corresponding video clips. Conventionally, an interactive video menu is created by manually allocating one or more items in a menu frame included in an interactive video, then repeatedly linking the items to playback commands for the corresponding video clips. Therefore, any portion such as a video clip of the interactive video can be easily accessed or played in response to a user selection made directly on it. Thereafter, aesthetic and organizational modifications can be further made thereto for a more satisfying outlook.

However, this is cumbersome and time-consuming. Therefore, other improvements can further be made so that a user can easily construct an interactive video menu for easy access to any portion of the interactive video. Further, there is a need to integrate the construction of the interactive video menu into the authoring of the interactive video, so that the authoring of the interactive video can be made more instinctively.

### SUMMARY OF THE INVENTION

It is therefore an object of the invention to provide a method for constructing an interactive video menu, which is usually applied to an interactive video authoring system and performed during the authoring of an interactive video, for easy access to any portion such as a video chapter of the interactive video. First, the invention is started with the establishment of an interactive video project. Thereafter, one or more video clips are added to the interactive video project, with each of the video clips represented with a video frame included therein. Thereafter, each of the video clips is parsed to identify one or more video chapters for the video clip, with each of the video chapters also represented with a video frame included therein. Next, a 2-level interactive video menu is constructed based on a menu template and the hierarchical relationship between the video clips and their corresponding video chapters, with the first-level menu including one or more first-level items respectively linked to a second-level menu for the corresponding video clip, and each of the second-level menus including one or more second-level items respectively linked to a playback command for the corresponding video chapter, so that each of the video chapters can be easily accessed or played in response to a user selection made on the resulting 2-level interactive video menu. Also, for a more professional design, the method also allows the user to preview the resulting 2-level interactive video menu, and making aesthetic or structural modifications thereto.

It is therefore another object of the invention to provide a system for constructing an interactive video menu, which is applied to an interactive video authoring system and performed during the authoring of an interactive video, for easy access to any portion such as a video chapter of the interactive video. The system comprises a video parsing module, a menu constructing module, and a hierarchy database. The video parsing module is provided to receive one or more video clips for the interactive video project, with each of the video clips represented by a video frame included therein, and to parse each of the video clips to identify one or more video chapters for the video clip, with each of the video chapters also represented with a video frame included therein. The hierarchy database that may be organized as a tree structure is coupled to the video parsing module and is provided to keep the hierarchical relationship between the video clips and their corresponding video chapters. The menu constructing module is coupled to the hierarchy database and is provided to construct a 2-level interactive video menu based on a menu template and the hierarchical relationship stored in the hierarchy database, in which the first-level menu includes one or more first-level items respectively linked to a second-level menu for the corresponding video clip, and each of the second-level menus includes one or more second-level items respectively linked to a playback command for the corresponding video chapter. Thus, each of the video chapters can be easily accessed or played in response to a user selection made on the resulting 2-level interactive video menu.

The objects, features, and advantages of the invention can be more fully understood by reading the following detailed description of the preferred embodiment, with reference made to the accompanying drawings, wherein:

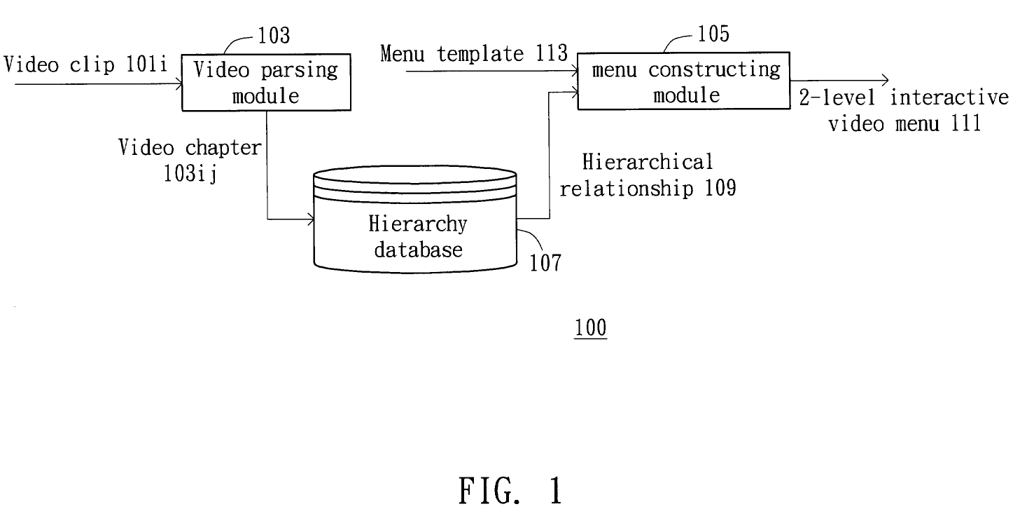

FIG. 1 is a block diagram showing a system for constructing an interactive video menu according to the preferred embodiment of this invention,

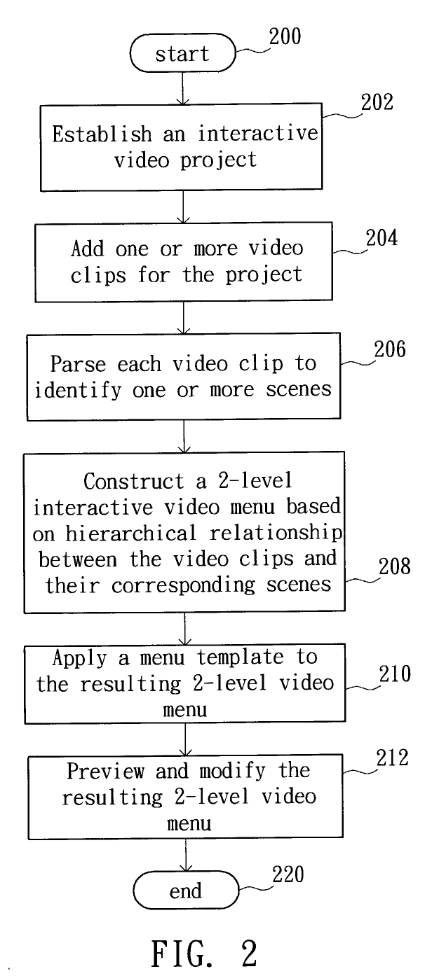

FIG. 2 is a flow chart showing a method for constructing an interactive video menu according to the preferred embodiment of the invention,

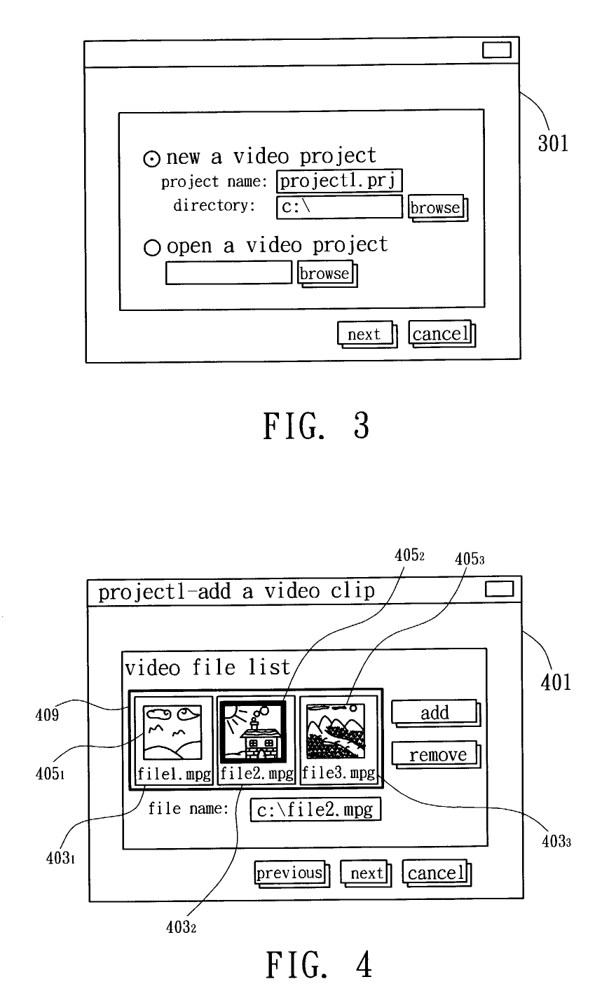

FIG. 3 is a startup window illustrating the establishment of an interactive video project, as shown in Step 202 of FIG. 2;

FIG. 4 is a clip selection window illustrating the selection of one or more video clips in an interactive video project, as shown in Step 204 of FIG. 2;

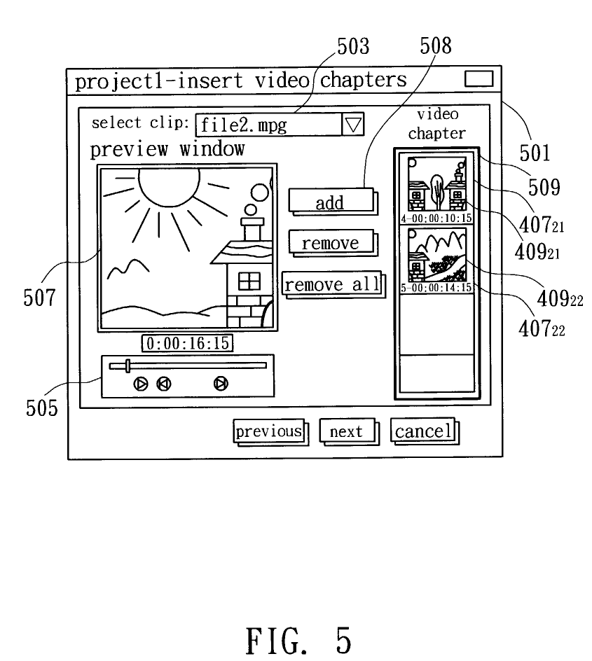

FIG. 5 is a video chapter selection window illustrating the selection of one or more video chapters in a video clip, as shown in Step 206 of FIG. 2;

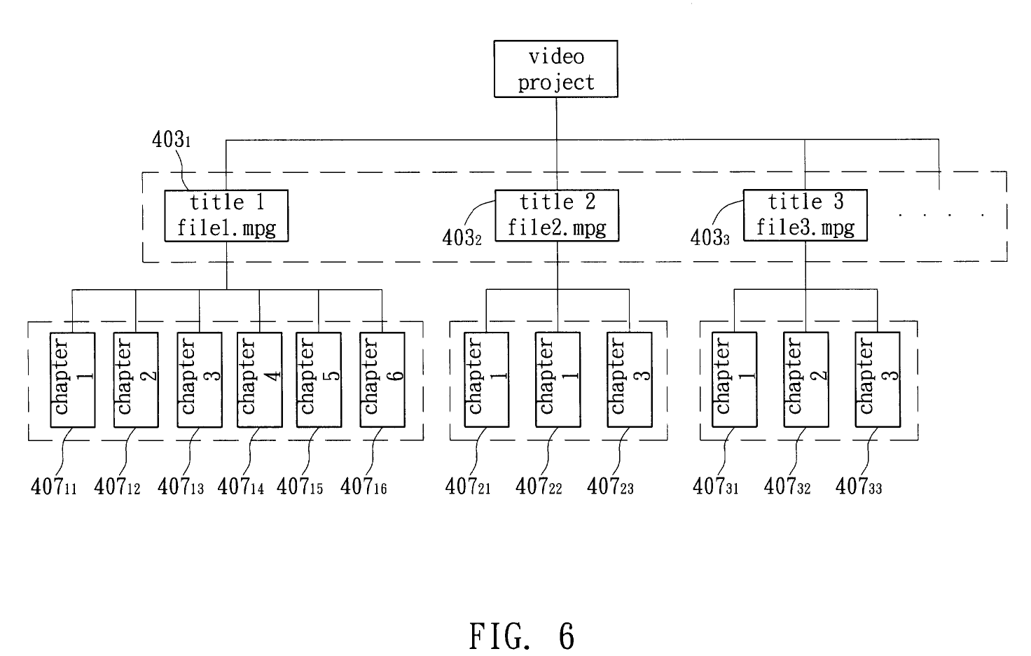

FIG. 6 is a tree structure showing the hierarchical relationship between the video clips and their corresponding video chapters according to the preferred embodiment of this invention;

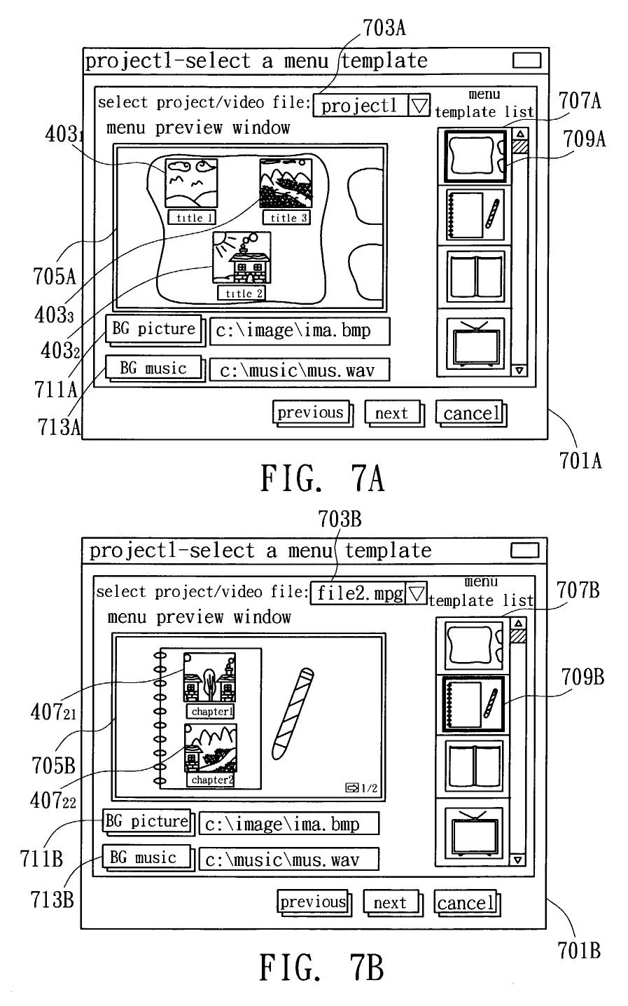

FIG. 7A is a template selection window illustrating the selection of a menu template for the first-level menu of the resulting 2-level interactive video menu;

FIG. 7B is a template selection window illustrating the selection of a menu template for the second-level menu of the resulting 2-level interactive video menu;

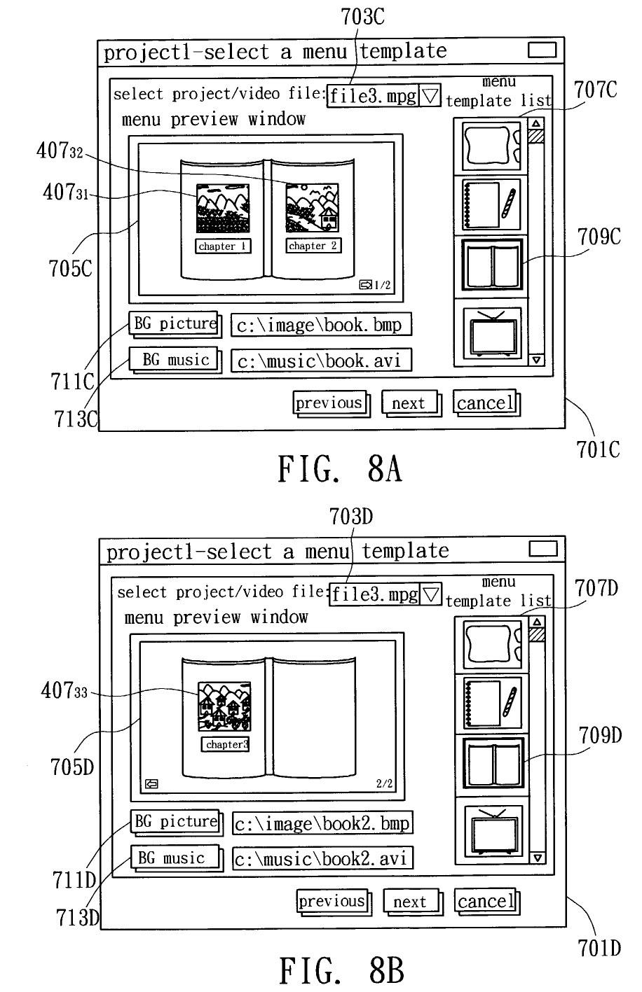

FIG. 8A and 8B are menu preview windows respectively showing a partial first-level menu of the 2-level interactive video menu when the items of the first-level menu are split up into two menu frames; and

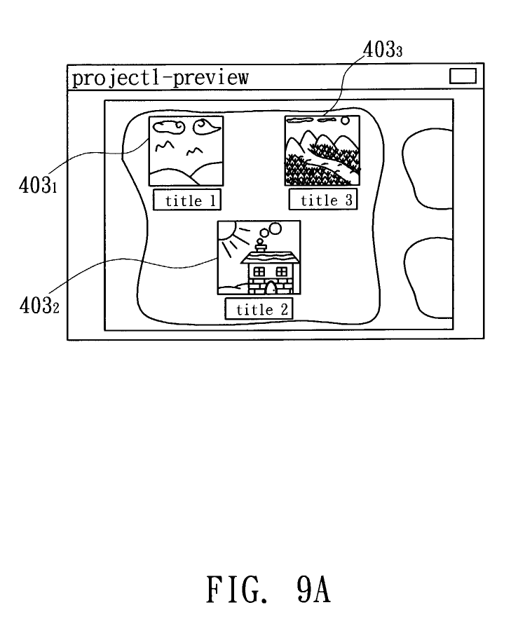

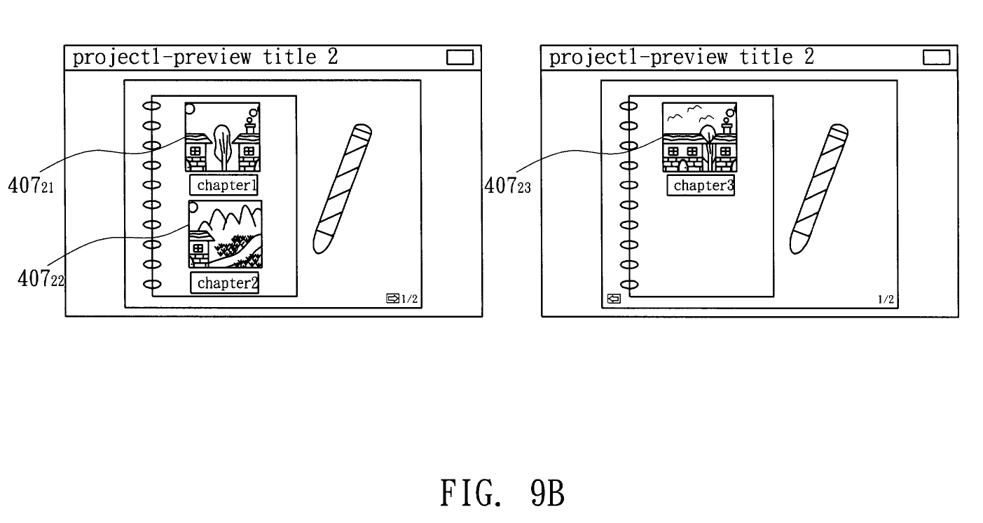

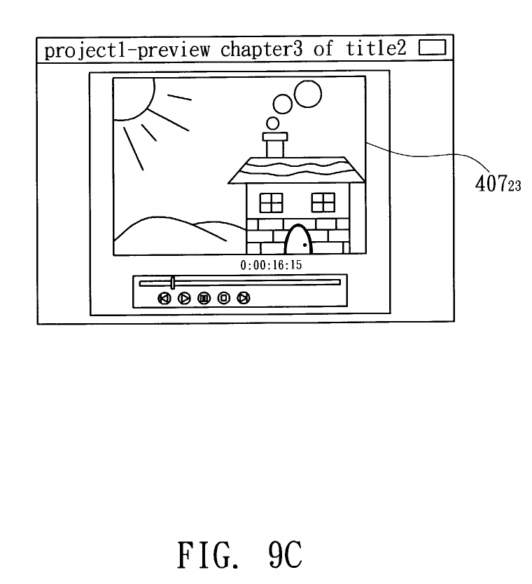

FIG. 9A, 9B and 9C are project preview windows respectively showing a first-level menu, a second-level menu, and a selected video chapter in response to a user selection made on the resulting 2-level interactive video menu.

### DETAILED DESCRIPTION OF THE INVENTION

The invention discloses a method and system for constructing a 2-level interactive video menu for easy access to any portion such as a video chapter included in an interactive video, which is applied to an interactive video authoring system and performed during the authoring of the interactive video. Please refer to FIG. 1, which is a block diagram showing a system for constructing an interactive video menu according to the preferred embodiment of the invention. As shown in FIG. 1, the system 100 comprises a video parsing module 103, a menu constructing module 105, and a hierarchy database 107. The video parsing module 103 is provided to receive one or more video clips 101ᵢ (where i is the index for the received video clips for an interactive video project) from any storage means, and to parse each of the video clips 101ᵢⱼ to identify one or more video chapters 103ᵢ included therein (where j is the index for the identified video chapters in the video clip 101ᵢ). The hierarchy database 107, coupled to the video parsing module 103, is provided to maintain the hierarchical relationship 109 between the received video clips 101ᵢ and the identified video chapters 103ᵢⱼ for use in the menu constructing module 105. The menu constructing module 105, coupled to the hierarchy database 107, is provided to construct a 2-level interactive video menu 111 based on a menu template 113 and the hierarchical relationship 109 maintained in the hierarchy database 107, with the first-level menu including one or more first-level items respectively linked to a second-level menu for the corresponding video clip, and each of the second-level menus including one or more second-level items respectively linked to a playback command for the corresponding video chapter.

Please refer to FIG. 2, which is a flow chart showing a method for constructing an interactive video menu according to the preferred embodiment of this invention.

In Step 202, an interactive video project is first established. Please refer to FIG. 3, which is a startup window showing the establishment of an interactive video project, as illustrated in Step 202 of FIG. 2. As shown in FIG. 3, the interactive video project can be a newly created interactive video project or an existing interactive video project that has been stored on any storage means. The user can, in the startup window 301, create a new interactive video project by assigning a project name and setting its destination location, or open an existing interactive video project from any storage means with the help of a file browser. Since the operations performed for an existing interactive video project is possibly partial to those performed for a newly created interactive video project. This embodiment will be exemplified with a newly created interactive video project.

Next, in Step 204, one or more video clips are added into the established interactive video project. Please refer to FIG. 4, which is a clip selection window showing the selection of one or more video clips for an interactive video project, as illustrated in Step 204 of FIG. 2. As shown in FIG. 4, the user can, in a clip selection window 401, add one or more video clips 403ᵢ stored on any storage means into a video clip list 409, with each video clip 403ᵢ represented by a video frame 405ᵢ such as the first video frame in the video clip (where i is the index for the video clip). Moreover, the video clips 403ᵢ in the video clip list 409 can be further modified such as deleted or reorganized with the help of various controls in the clip selection window 401. In this example, the user adds three video clips 403₁, 403₂ and 403₃ in the video clip list 409 with the help of a file browser. Each of the video clips 403₁, 403₂ and 403₃ is respectively referred to file1.mpg, file2.mpg and file3.mpg stored in hard drive C, and is respectively represented with the first video frame 405₁, 405₂ and 405₃ included therein. In other examples, the user can draw-and-drop to reorganize the sequence of the added video clips 403₁, 403₂ and 403₃, or delete any of the video clips 403₁, 403₂ and 403₃ with the help of a remove control (if necessary).

Next, in Step 206, each of the video clips 403ᵢ is parsed to identify one or more video chapters 407ᵢⱼ included therein. As shown in FIG. 5, which is a chapter selection window showing the selection of one or more video chapters in a video clip, as illustrated in Step 206 of FIG. 2. As shown in FIG. 5, the user can, in a chapter selection window 501, select one of the video clips 403ᵢ with the help of a selection combo 503, into a video chapter list 509, and parse the selected video clip with the help of a preview navigator 505 and a preview window 507 to identify one or more video chapters 407ᵢⱼ contained therein, with each of the video chapters 407ᵢⱼ also represented with a video frame 409ᵢⱼ such as the first video frame of the selected video chapter (where j is the index for the identified video chapter in the video clip 403ᵢ). In this embodiment, the parsing step can be performed by previewing one and all video frames of the selected video clip with the help of the selection combo 503, the preview navigation 505 and the preview window 507, and identifying one or more video chapters 407ᵢⱼ by picking certain video frames from the selected video clip to a video chapter list 509 with the help of an add control. Moreover, the user can also remove any selected video chapters from the video chapter list 509 with the help of a remove control (if necessary). As shown in FIG. 5, the user selects the video clip 403₂ with the help of the selection combo 503, preview one and all video frames of the selected video clip 403₂ with the help of the navigation bar 505 and preview window 507, and identify two video chapters 403₂₁ and 403₂₂ respectively starting at 00:00:10:15 and at 00:00:14:15 into the video chapter list 509 with the help of an add control 508. This parsing step is repeated until each of video clips 403₁, 403₂, 403₃ is parsed.

In Step 208, a 2-level interactive video menu is constructed based on the hierarchical relationship between the received video clips 403ᵢ and their corresponding video chapters 407ᵢⱼ, which is stored in a hierarchy database 107 (as shown in FIG. 1). Please refer to FIG. 6, which is a tree structure illustrating the hierarchical relationship between the received video clips and their corresponding video chapters according the preferred embodiment of this invention. As shown in FIG. 6, the interactive video project includes three video clips 403₁, 403₂ and 403₃, with the first video clip 403₁ including six video chapter 407₁₁, 407₁₂, . . . , 407₁₆ contained therein, the second video clip 403₂ including three video chapters 407₂₁, 407₂₂ and 407₂₃ contained therein, and the third video clip 403₂ including three video chapters 407₃₁, 407₃₂ and 407₃₃ contained therein. Based on the tree structure in FIG. 6, a 2-level interactive video menu (not shown) can be determined with the first-level menu including three first-level items respectively linked to three second-level menus for the corresponding video clips 403₁, 403₂ and 403₃, and each of the second-level menus including a number of second-level items respectively linked to playback commands for the corresponding video chapters 407₁₁˜407₁₆, 407₂₁˜407₂₃ and 407₃₁˜407₃₃.

Next, in Step 210, a menu template can be applied to the resulting 2-level interactive video menu. Please refer to FIG. 7A and 7B, which are template selection windows respectively illustrating the selection of a menu template for the first-level menu and the selection of a menu template for a second-level menu. As shown in FIG. 7A, which is a template selection window illustrating the selection of a menu template for the first-level menu of the resulting 2-level interactive video menu. In this example, the user can, in a template selection window 701A, select a desired menu template 709A from a menu template list 707A, preview the resulting first-level menu with the help of a menu preview window 705A to determine the desired menu template 709A for the first-level menu. Moreover, the user can also modify the first-level menu by adding background music or image for the resulting first-level menu with the help of BG picture control 711A and BG music control 713A. As shown in FIG. 7B, which is a template selection window illustrating the selection of a menu template for the second-level menu of the resulting 2-level interactive video menu. In this example, the user can, in a template selection window 701B, identify a desired menu template 709B from a menu template list 707B, preview the resulting second-level menu in a menu preview window 705B to select the desired menu template 709B for the second-level menu. Moreover, the user can also modify the second-level menu by adding background music or image for the resulting second-level menu with the help of BG picture control 711B and BG music control 713B. Since the behaviors for the menu template selection for the first-level menu and the second-level menus are similar, in the preferred embodiment, the menu template selection for the first-level menu and the second-level menu can be implemented in the same menu template window, with the first-level menu and the second-level menus selected with the help of a selection combo 703A and 703B, as shown in FIG. 7A and 7B.

Moreover, the first-level menu and the second-level menus of the 2-level menu can be split up into multiple menu frames when the items to be included exceed that supported by the selected menu template. FIG. 8A and 8B are menu preview windows respectively showing a partial second-level menu of the resulting 2-level interactive video menu when the items to be included exceed that supported by the selected menu template. In this example, the video clip 403₃ includes three video chapters 407₃₁, 407₃₂ and 407₃₃. However, the selected menu template can support only two items in each menu frame, thus the resulting second-level menu for the video clip 403₃ is split up into two menu frames, with the first menu frame including two items respectively linked to playback commands for the first video chapter 407₃₁ and the second video chapter 407₃₂, and the second menu frame including one item linked to playback command for the third video chapter 407₃₃. Similar situations may occur for the first-level menu, therefore the related description thereof is omitted.

Next, in Step 212, the resulting 2-level interactive video menu for this interactive video project is previewed. Please refer to FIG. 9A, 9B, and 9C, which are project preview windows respectively showing the resulting first-level menu, the resulting second-level menu, and the resulting video chapters to be played, in which the video chapters 407₂₃ is played in response to a user selection that is sequentially made to the first-level item linked to a second-level menu for the video clip 403₂ and the second-level item linked to playback commands for the video chapter 407₂₃, which is located in the second menu frame of the second-level menu.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method of constructing an interactive video menu, which is applied in an interactive video authoring system and performed during the authoring of an interactive video, comprising the steps of:
establishing an interactive video project;
adding one or more video clips into the interactive video project, wherein each of the video clips is represented with a clip frame therein;
parsing each of the video clips to identify one or more video chapters, wherein each of the video chapters is represented with a chapter frame therein; and
constructing a 2-level interactive video menu based on a menu template and hierarchical relationship between the video clips and the corresponding video chapters, with a first-level menu of the 2-level interactive video menu comprising one or more first-level items linked to second-level menus for the corresponding video clips, and each of the second-level menus of the 2-level interactive video menu comprising one or more second-level items linked to playback commands for the corresponding video chapters.

2. The method of constructing an interactive video menu according to claim 1, wherein the first-level menu is split up into multiple menu frames when the first-level items exceed that supported by the menu template.

3. The method of constructing an interactive video menu according to claim 1, wherein each of the second-level menus is split up into multiple menu frames when the second-level items exceed that supported by the menu template.

4. The method of constructing an interactive video menu according to claim 1, wherein the method further comprises:
previewing the interactive video project after the menu template is selected.

5. A system for constructing a interactive video menu, which is applied to an interactive video authoring system and performed during the authoring of an interactive video, said system comprising:
a video parsing module for receiving one or more video clips and parsing each of the video clips to identify one or more video chapters included therein;
a hierarchy database for maintaining hierarchical relationship between the video clips and the corresponding video chapters; and
a menu constructing module for constructing a 2-level interactive video menu based on a menu template and the hierarchical relationship, with a first-level menu of the 2-level interactive video menu comprising one or more first-level items respectively linked to second-level menus for the corresponding video clips, and each of the second-level menus comprising one or more second-level items respectively linked to playback commands for the corresponding video chapters.

6. A computer-readable recording media, for recording a method of constructing an interactive video menu, which is applied in an interactive video authoring system and performed during the authoring of an interactive video, the method comprising:
establishing an interactive video project;
adding one or more video clips into the interactive video project, wherein each of the video clips is represented with a clip frame therein;
parsing each of the video clips to identify one or more video chapters, wherein each of the video chapters is represented with a chapter frame therein; and
constructing a 2-level interactive video menu based on a menu template and hierarchical relationship between the video clips and the corresponding video chapters, with a first-level menu of the 2-level interactive video menu comprising one or more first-level items linked to second-level menus for the corresponding video clips, and each of the second-level menus of the 2-level interactive video menu comprising one or more second-level items linked to playback commands for the corresponding video chapters.

7. The computer-readable recording media according to claim 6, wherein first-level menu is split up into multiple menu frames when the first-level items exceed that supported by the menu template.

8. The computer-readable recording media according to claim 6, wherein first-level menu is split up into multiple menu frames when the second-level items exceed that supported by the menu template.

9. The computer-readable recording media according to claim 6, wherein the method further comprises:
previewing the interactive video project after the menu template is selected.
